(19) United States
(12) Patent Application Publication
(10) Pub. No.: US 2013/0244649 A1
(43) Pub. Date: Sep. 19, 2013

(54) Method of Transferring Short Message Service

(71) Applicant: HTC CORPORATION, Taoyuan County (TW)

(72) Inventors: Ching-Yu Liao, Taoyuan County (TW); Kundan Tiwari, Taoyuan County (TW)

(73) Assignee: HTC CORPORATION, Taoyuan County (TW)

(21) Appl. No.: 13/847,464

(22) Filed: Mar. 19, 2013

Related U.S. Application Data
(60) Provisional application No. 61/612,823, filed on Mar. 19, 2012.
(60) Provisional application No. 61/614,760, filed on Mar. 23, 2012.

(51) Int. Cl. H04W 4/14

(52) U.S. Cl. CPC H04W 4/14
USPC 455/435.1

(57) ABSTRACT

A method of transferring a short message service (SMS) to a communication device in a wireless communication system comprises a network of the wireless communication system not activating an idle-mode signaling reduction (ISR) mode for the communication device when the network applies only PS domain registration for the SMS for the communication device.

### CROSS REFERENCE TO RELATED APPLICATIONS

This application claims the benefit of U.S. Provisional Application No. 61/612,823, filed on Mar. 19, 2012 and entitled “Method of handling PS domain paging for SMS service when ISR is active”, and the benefit of U.S. Provisional Application No. 61/614,760, filed on Mar. 23, 2012 and entitled “Method to transfer SMS to the PS only devices”, the contents of which are incorporated herein in their entirety.

### BACKGROUND OF THE INVENTION

1. Field of the Invention

The present invention relates to a method in a wireless communication system, and more particularly, to a method of transferring a short message service (SMS) to a communication device in a wireless communication system.

2. Description of the Prior Art

A long-term evolution (LTE) system supporting the 3GPP Rel-8 standard and/or the 3GPP Rel-9 standard is developed by the 3rd Generation Partnership Project (3GPP) as a successor of a universal mobile telecommunications system (UMTS), for further enhancing performance of the UMTS to satisfy users' increasing needs. The LTE system includes a new radio interface and radio network architecture that provides a high data rate, low latency, packet optimization, and improved system capacity and coverage. In the LTE system, a radio access network known as an evolved UTRAN (E-UTRAN) includes multiple evolved NBs (eNBs) for communicating with multiple user equipments (UEs), and communicates with a core network including a mobility management entity (MME), serving gateway, etc. The MME is responsible for delivery of data packets to the mobile devices back and forth within its geographical service area, including packet routing and transfer, mobility management (attach/detach and location management), logical link management, and authentication and charging functions. The MME also provides the control plane function for mobility between LTE and 2G/3G access networks with the S3 interface terminating at the MME from the SGSN.

A packet-switched (PS) only device represents a device with only PS capability or with only the PS capability activated. In the prior art, a PS only device having activated an idle-mode signaling reduction (ISR) mode registers to a PS domain only, and a short message service (SMS) service corresponding to the PS only device must be delivered via the PS domain. If PS network nodes (such as the MME or the SGSN) do not support the SMS service through the PS services, the SMS service may be transferred through a circuit-switched (CS) service. However, the PS only device may fail to respond a CS paging message since the PS only device does not register to a CS domain. In addition, when the PS only device is attached to the MME and the SGSN at the same time, a location of the PS only device is uncertain, such that errors may occur when transferring the SMS service.

### SUMMARY OF THE INVENTION

The present invention therefore provides a method of transferring a short message service (SMS) to solve the above-mentioned problems.

A method of transferring a short message service (SMS) to a communication device in a wireless communication system is disclosed. The method comprises a network of the wireless communication system not activating an idle-mode signaling reduction (ISR) mode for the communication device when the network applies only PS domain registration for the SMS for the communication device.

A method of transferring a short message service (SMS) to a communication device having activated an idle-mode signaling reduction (ISR) mode in a wireless communication system comprising a short message service gateway mobile switching center (SMS-GMSC) and a home location register (HLR)/home subscriber server (HSS) is disclosed. The method comprises the SMS-GMSC querying a routing information from the HLR; and the SMS-GMSC sending a message indicating support of evolved packet system (EPS) and general packet radio service (GPRS).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a flowchart of a process according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

FIG. 7 is a flowchart of a process according to an example of the present invention.

FIG. 8 is a flowchart of a process according to an example of the present invention.

### DETAILED DESCRIPTION

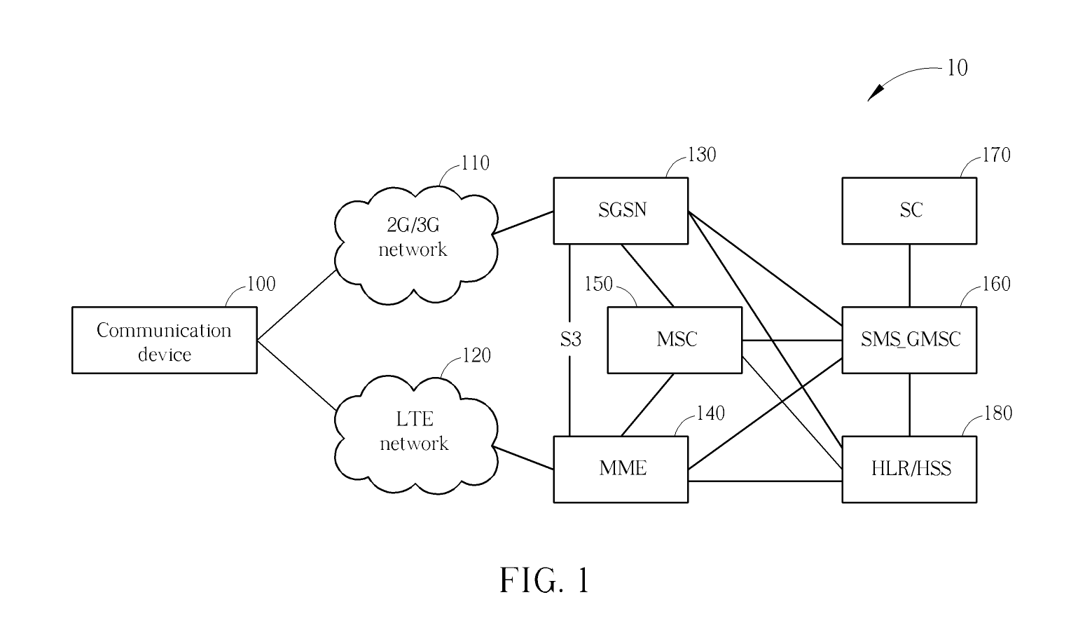

Please refer to FIG. 1, which is a schematic diagram of a wireless communication system 10 according to an example of the present invention. The wireless communication system comprises a communication device 100, a 2G/3G network 110, a long-term evolution (LTE) network 120, a serving GPRS support node (SGSN) 130, a mobility management entity (MME) 140, a mobile switching center (MSC) 150, a short message service gateway mobile switching center (SMS-GMSC) 160, a service center (SC) 170, and a home location register (HLR)/home subscriber server (HSS) 180. The communication device 100 connects to the MME 140 and the SGSN 130 through the 2G/3G network 110 and the LTE network 120 respectively, and the MME 140 and the SGSN 130 communicate to each other through an S3 interface. The MSC 150 connects to the SGSN 130, the MME 140, and the SMS-GMSC 160, and is utilized for providing a circuit-switched (CS) service. The SMS-GMSC connects to the SGSN 130, the MME 140, the MSC 150, the SC 170, and HLR/HSS 180, and is utilized for sending short messages to the SGSN 130, the MME 140, and the MSC 150. The HLR/HSS 180 connects to the SGSN 130, the MME 140, the MSC 150, and the SMS-GMSC 160, and is utilized for providing addresses of the SGSN 130, the MME 140, and the MSC 150 to the SMS-GMSC 160. Please note that, some of connections in the wireless communication system 10 may not exist in other communication systems. For example, in a pure LTE system, there is no connection between the MME 140 and the MSC 150. All similar communication systems are still included in the scope of the present invention.

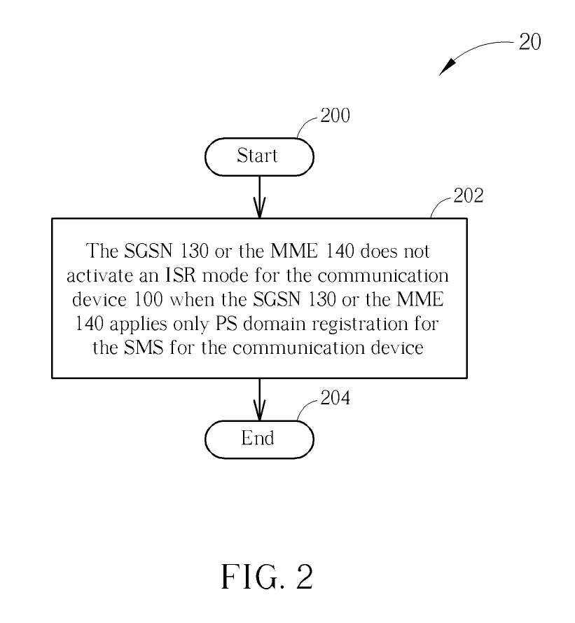

Please refer to FIG. 2, which is a flowchart of a process 20 according to an example of the present invention. The process 20 is utilized for the wireless communication system 10 shown in FIG. 1, for transferring a short message service (SMS) when the communication device 100 is a packet-switched (PS) only communication device. The process 20 includes the following steps:

Step 200: Start.

Step 202: The SGSN 130 or the MME 140 does not activate an idle-mode signaling reduction (ISR) mode for the communication device 100 when the SGSN 130 or the MME 140 applies only PS domain registration for the SMS for the communication device.

Step 204: End.

In the process 20, the SGSN 130 or the MME 140 does not activate the ISR mode for the communication device 100 when the SGSN 130 or the MME 140 applies only PS domain registration for the SMS for the communication device, such that the communication device 100 must perform a location registration procedure when the communication device 100 changes from the 2G/3G network 110 to the LTE network 120. Through performing the location registration procedure by the communication device 100, the HLR/HSS 180 can always know a location of the communication device 100 (the location of the communication device 100 is not certain if the communication device 100 is activated the IRS mode), and provides the location of the communication device 100 to the SMS-GMSC 160 for delivering a short message to the communication device 100.

The process 20 can avoid uncertainty of the location of the communication device 100 by not activating the ISR mode for the communication device 100. In addition, the present invention further provides several methods for transferring a SMS when the communication device 100 is activated the ISR mode.

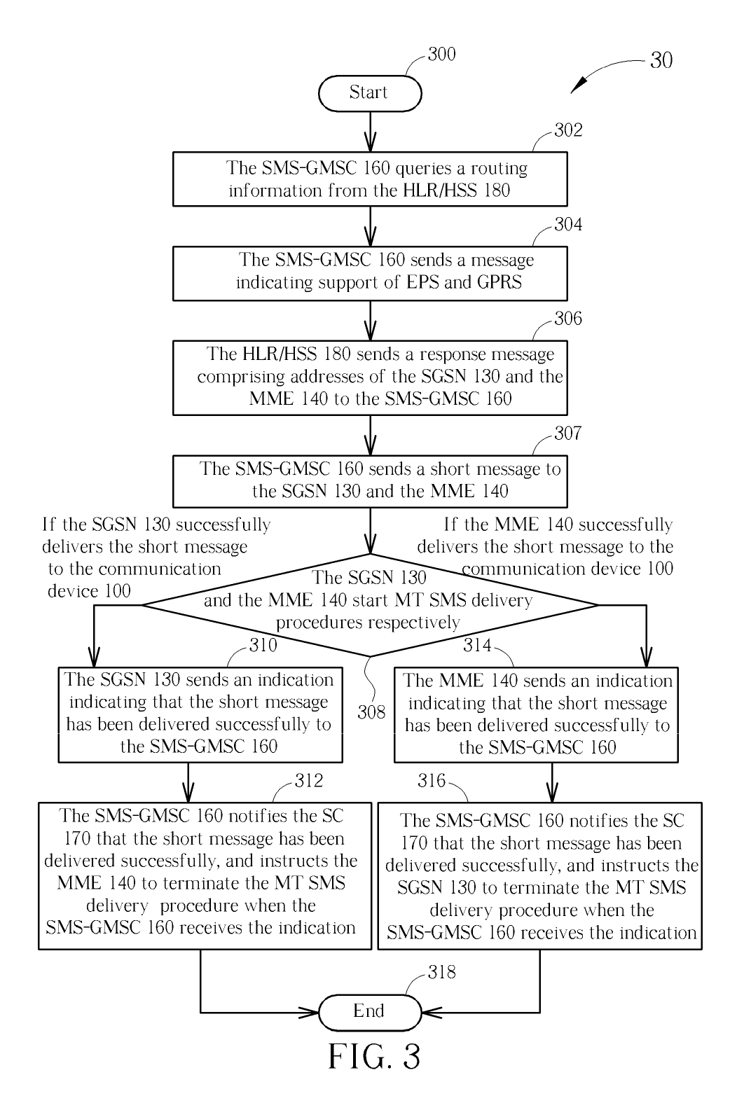

Please refer to FIG. 3, which is a flowchart of a process 30 according to an example of the present invention. The process 30 is utilized in the wireless communication system 10 shown in FIG. 1, for transferring a SMS when the communication device 100 is a packet-switched (PS) only communication device having activated the ISR mode. The process 30 includes the following steps:

Step 300: Start.

Step 302: The SMS-GMSC 160 queries a routing information from the HLR/HSS 180.

Step 304: The SMS-GMSC 160 sends a message indicating support of evolved packet system (EPS) and general packet radio service (GPRS).

Step 306: The HLR/HSS 180 sends a response message comprising addresses of the SGSN 130 and the MME 140 to the SMS-GMSC 160.

Step 307: The SMS-GMSC 160 sends a short message to the SGSN 130 and the MME 140.

Step 308: The SGSN 130 and the MME 140 start mobile terminated (MT) SMS delivery procedures respectively. If the SGSN 130 successfully delivers the short message to the communication device 100, go to step 310. If the MME 140 successfully delivers the short message to the communication device 100, go to step 314.

Step 310: The SGSN 130 sends an indication indicating that the short message has been delivered successfully to the SMS-GMSC 160.

Step 312: The SMS-GMSC 160 notifies the SC 170 that the short message has been delivered successfully, and instructs the MME 140 to terminate the MT SMS delivery procedure when the SMS-GMSC 160 receives the indication. Go to step 318.

Step 314: The MME 140 sends an indication indicating that the short message has been delivered successfully to the SMS-GMSC 160.

Step 316: The SMS-GMSC 160 notifies the SC 170 that the short message has been delivered successfully, and instructs the SGSN 130 to terminate the MT SMS delivery procedure when the SMS-GMSC 160 receives the indication.

Step 318: End.

In the process 30, the SMS-GMSC 160 queries the routing information from the HLR/HSS 180 and sends the message indicating support of EPS and GPRS. Then, the HLR/HSS 180 sends the response message comprising the addresses of the SGSN 130 and the MME 140 back to the SMS-GMSC 160. Therefore, the SMS-GMSC 160 can send the short message to the SGSN 130 and the MME 140. Since both the SGSN 130 and the MME 140 get the short message, the SGSN 130 and the MME 140 can start the MT SMS delivery procedures respectively to deliver the short message. The node (one of the SGSN 130 and the MME 140) which delivers the short message successfully sends the indication indicating that the short message has been delivered successfully to the SMS-GMSC 160, and the other node (the other one of the SGSN 130 and the MME 140) is instructed to terminate the MT SMS delivery procedure by the SMS-GMSC 160, to reduce unnecessary signaling.

In the process 30, the SMS-GMSC 160 delivers the short message through a PS domain only. Considering the communication device 100 which registers to a CS domain and the PS domain simultaneously, the SMS-GMSC 160 can deliver the short message through both the CS domain and the PS domain.

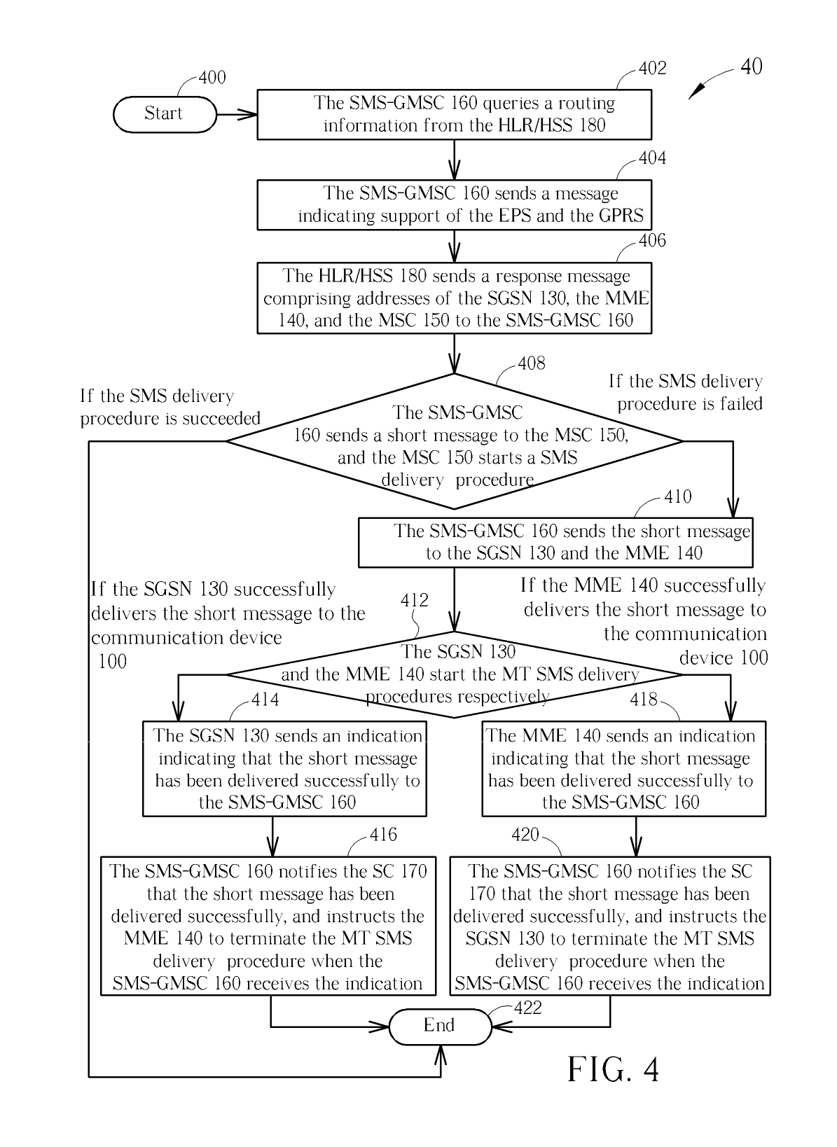

Please refer to FIG. 4, which is a flowchart of a process 40 according to an example of the present invention. The process 40 is utilized in the wireless communication system 10 shown in FIG. 1, for transferring a SMS when the communication device 100 is a packet-switched (PS) only communication device having activated the ISR mode with registrations of both the CS domain and the PS domain. The process 40 includes the following steps:

Step 400: Start.

Step 402: The SMS-GMSC 160 queries a routing information from the HLR/HSS 180.

Step 404: The SMS-GMSC 160 sends a message indicating support of the EPS and the GPRS.

Step 406: The HLR/HSS 180 sends a response message comprising addresses of the SGSN 130, the MME 140, and the MSC 150 to the SMS-GMSC 160.

Step 408: The SMS-GMSC 160 sends a short message to the MSC 150, and the MSC 150 starts a SMS delivery procedure. If the SMS delivery procedure is failed, go to step 410. If the SMS delivery procedure is succeeded, go to step 422.

Step 410: The SMS-GMSC 160 sends the short message to the SGSN 130 and the MME 140.

Step 412: The SGSN 130 and the MME 140 start the MT SMS delivery procedures respectively. If the SGSN 130 successfully delivers the short message to the communication device 100, go to step 414. If the MME 140 successfully delivers the short message to the communication device 100, go to step 418.

Step 414: The SGSN 130 sends an indication indicating that the short message has been delivered successfully to the SMS-GMSC 160.

Step 416: The SMS-GMSC 160 notifies the SC 170 that the short message has been delivered successfully, and instructs the MME 140 to terminate the MT SMS delivery procedure when the SMS-GMSC 160 receives the indication. Then, Go to step 422.

Step 418: The MME 140 sends an indication indicating that the short message has been delivered successfully to the SMS-GMSC 160.

Step 420: The SMS-GMSC 160 notifies the SC 170 that the short message has been delivered successfully, and instructs the SGSN 130 to terminate the MT SMS delivery procedure when the SMS-GMSC 160 receives the indication.

Step 422: End.

As can be seen by comparing the process 30 and the process 40, the process 30 and the process 40 are similar, and a difference between the process 30 and the process 40 is that the HLR/HSS 180 sends a response message comprising addresses of the SGSN 130, the MME 140, and the MSC 150 to the SMS-GMSC 160, and the SMS-GMSC 160 sends the message to the MSC 150 first. If the MSC 150 delivers the short message successfully (i.e. through the CS domain), the process 40 is ended. Otherwise, if the MSC 150 fails to deliver the short message, the SMS-GMSC 160 sends the short message to the SGSN 130 and the MME 140 (i.e. delivers the short message through the PS domain). The rest of the process 40 is the same as the process 30, and can be referred to the above description.

Note that, an order of sending the short message in the process can be change. Those skilled in the art should readily make combinations, modifications and/or alterations on the abovementioned description and examples.

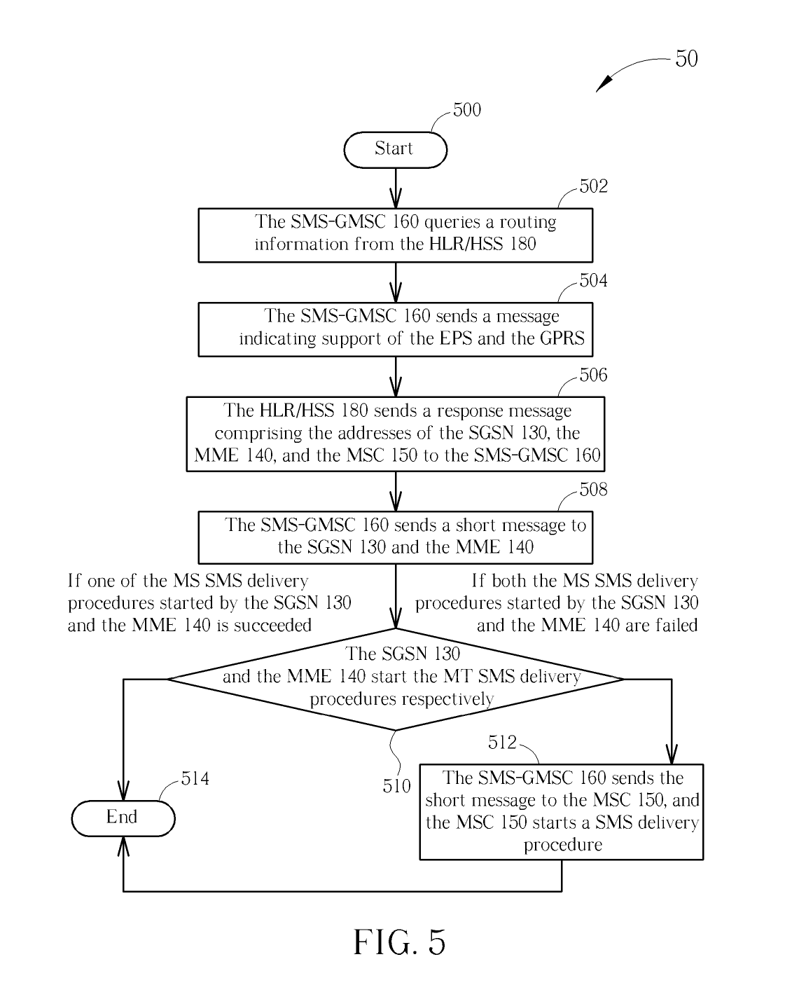

For example, please refer to FIG. 5, which is a flowchart of a process 50 according to an example of the present invention. The process 50 is utilized in the wireless communication system 10 shown in FIG. 1, for transferring a SMS when the communication device 100 is a packet-switched (PS) only communication device having activated the ISR mode with registrations of both the CS domain and the PS domain. The process 50 includes the following steps:

Step 500: Start.

Step 502: The SMS-GMSC 160 queries a routing information from the HLR/HSS 180.

Step 504: The SMS-GMSC 160 sends a message indicating support of the EPS and the GPRS.

Step 506: The HLR/HSS 180 sends a response message comprising the addresses of the SGSN 130, the MME 140, and the MSC 150 to the SMS-GMSC 160.

Step 508: The SMS-GMSC 160 sends a short message to the SGSN 130 and the MME 140.

Step 510: The SGSN 130 and the MME 140 start the MT SMS delivery procedures respectively. If both the MS SMS delivery procedures started by the SGSN 130 and the MME 140 are failed, go to step 512. If one of the MS SMS delivery procedures started by the SGSN 130 and the MME 140 is succeeded, go to step 514.

Step 512: The SMS-GMSC 160 sends the short message to the MSC 150, and the MSC 150 starts a SMS delivery procedure.

Step 514: End.

As can be seen by comparing the process 50 and the process 40, the process 50 and the process 40 are similar, and a difference between the process 50 and the process 40 is that the SMS-GMSC 160 sends the short message to the SGSN 130 and the MME 140 first (i.e. through PS domain). In the same way, the SMS-GMSC 160 can send the short message to the SGSN 130 and the MME 140 one by one.

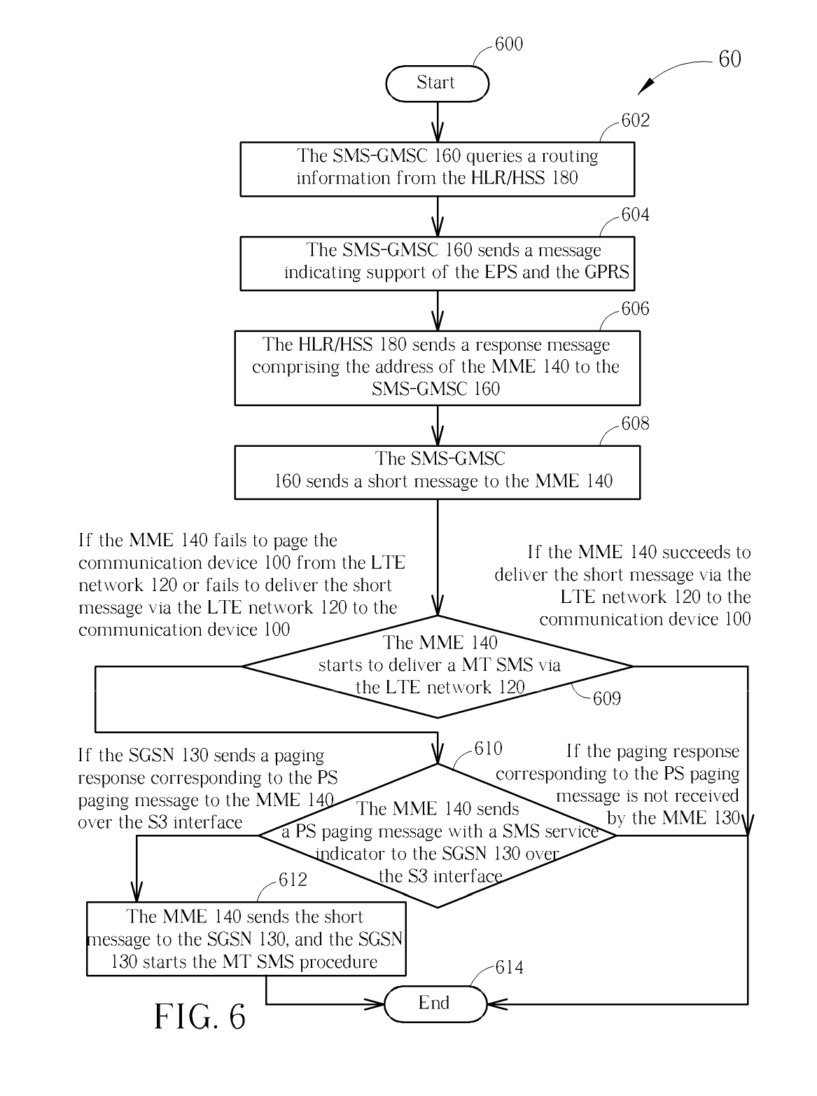

For example, please refer to FIG. 6, which is a flowchart of a process 60 according to an example of the present invention. The process 60 is utilized in the wireless communication system 10 shown in FIG. 1, for transferring a SMS when the communication device 100 is a PS only communication device having activated the ISR mode. The process 60 includes the following steps:

Step 600: Start.

Step 602: The SMS-GMSC 160 queries a routing information from the HLR/HSS 180.

Step 604: The SMS-GMSC 160 sends a message indicating support of the EPS and the GPRS.

Step 606: The HLR/HSS 180 sends a response message comprising the address of the MME 140 to the SMS-GMSC 160.

Step 607: The SGSN 130 uses an allocated packet-temporary mobile subscriber identity (P-TMSI) or international mobile subscriber identity (IMSI) as a temporary identity.

Step 608: The SMS-GMSC 160 sends a short message to the MME 140.

Step 609: The MME 140 starts to deliver a MT SMS via the LTE network 120. If the MME 140 fails to page the communication device 100 from the LTE network 120 or fails to deliver the short message via the LTE network 120 to the communication device 100, go to step 610. If the MME 140 succeeds to deliver the short message via the LTE network 120 to the communication device 100, go to step 614.

Step 610: The MME 140 sends a PS paging message with a SMS service indicator to the SGSN 130 over the S3 interface. If the SGSN 130 sends a paging response corresponding to the PS paging message to the MME 140 over the S3 interface, go to step 612. If the paging response corresponding to the PS paging message is not received by the MME 140, go to 614.

Step 612: The MME 140 sends the short message to the SGSN 130, and the SGSN 130 starts the MT SMS delivery procedure. Go to step 614.

Step 614: End.

In the process 60, the SMS-GMSC 160 sends the short message to the MME 140 only, and then the MME 140 and the SGSN 130 communicate to each other by the S3 interface, to decide that which node (the MME 140 or the SGSN 130) need to start the MT SMS delivery procedure. Note that, in the process 60, the PS paging message is sent to the SGSN 130, but is not limited thereto. For example, the MME 130 may send a CS paging message with a service indicator setting as “PS SMS indicator” to the SGSN 130. Since the communication device 100 is PS only, the SGSN 130 sends a PS paging instead of the CS paging message over the PS domain to the communication device 100, to avoid that the communication device 100 fails to response the CS paging message. Such modification can still deliver the short message successfully.

Note that, in the process 60, only one node (the MME 140 or the SGSN 130) starts the MT SMS delivery procedure, but is not limited thereto.

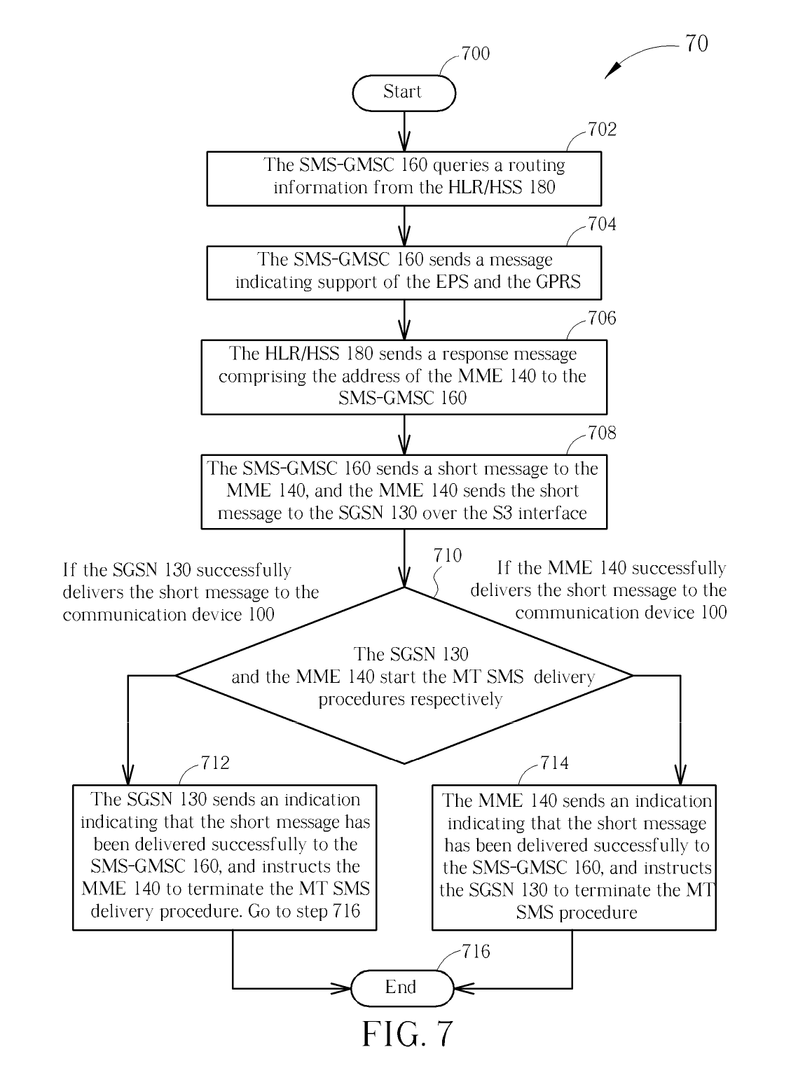

For example, please refer to FIG. 7, which is a flowchart of a process 70 according to an example of the present invention. The process 70 is utilized in the wireless communication system 10 shown in FIG. 1, for transferring a SMS when the communication device 100 is a PS only communication device having activated the ISR mode. The process 70 includes the following steps:

Step 700: Start.

Step 702: The SMS-GMSC 160 queries a routing information from the HLR/HSS 180.

Step 704: The SMS-GMSC 160 sends a message indicating support of the EPS and the GPRS.

Step 706: The HLR/HSS 180 sends a response message comprising the address of the MME 140 to the SMS-GMSC 160.

Step 708: The SMS-GMSC 160 sends a short message to the MME 140, and the MME 140 sends the short message to the SGSN 130 over the S3 interface.

Step 710: The SGSN 130 and the MME 140 start the MT SMS delivery procedures respectively. If the SGSN 130 successfully delivers the short message to the communication device 100, go to step 712. If the MME 140 successfully delivers the short message to the communication device 100, go to step 714.

Step 712: The SGSN 130 sends an indication indicating that the short message has been delivered successfully to the SMS-GMSC 160, and instructs the MME 140 to terminate the MT SMS delivery procedure. Go to step 716.

Step 714: The MME 140 sends an indication indicating that the short message has been delivered successfully to the SMS-GMSC 160, and instructs the SGSN 130 to terminate the MT SMS delivery procedure.

Step 716: End.

In the process 70, the HLR/HSS 180 provides the address of the MME 140 only, such that the SMS-GMSC 160 must send the short message to the MME 140. However, the MME 140 and the SGSN 130 can communicate over the S3 interface, and thus the MME 140 can send the short message through the S3 interface. In addition, the node (the MME 140 or the SGSN 130) which successfully delivers the short message instructs the other node to terminate the MT SMS delivery procedure since the SMS-GMSC 160 has the address of the MME 140 only (i.e. the SMS-GMSC 160 can not instruct the SGSN 130 to terminate the MT SMS delivery procedure). Note that, in the process 70, the HLR/HSS 180 may provide the address of the SGSN 130 instead of the address of the MME 140, the SMS-GMSC 160 must send the short message to the SGSN 130, and execute the following steps by switching the SGSN 130 and the MME 140. Those skilled in the art should readily make combinations, modifications and/or alterations on the abovementioned description and examples.

Note that, the above-mentioned processes send the short message directly to the communication device 100 through the SGSN 130 or the MME 140 without considering whether the communication device 100 is in the 2G/3G network 110 or the LTE network 120. By redirecting the communication device 100 between the 2G/3G network 110 and the LTE network 120, the short message can be sent through a specific network (the 2G/3G network 110 or the LTE network 120).

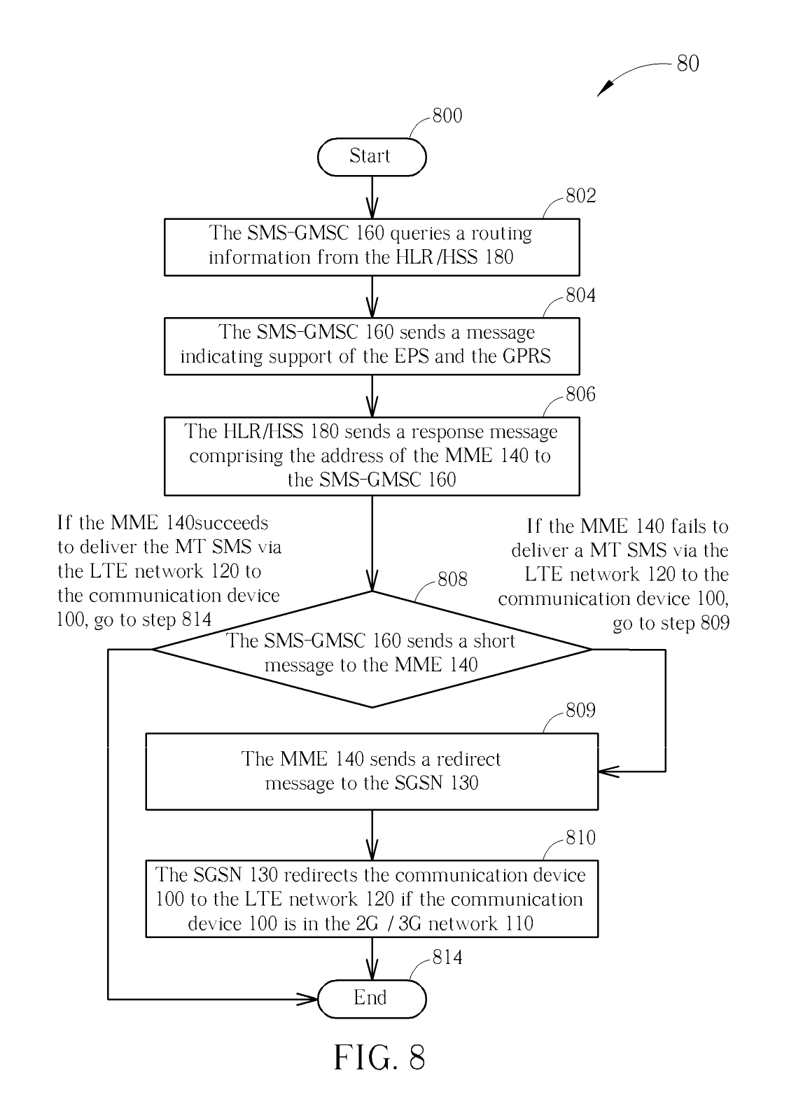

For example, please refer to FIG. 8, which is a flowchart of a process 80 according to an example of the present invention. The process 80 is utilized in the wireless communication system 10 shown in FIG. 1, for transferring a SMS when the communication device 100 is a PS only communication device having activated the ISR mode. The process 80 includes the following steps:

Step 800: Start.

Step 802: The SMS-GMSC 160 queries a routing information from the HLR/HSS 180.

Step 804: The SMS-GMSC 160 sends a message indicating support of the EPS and the GPRS.

Step 806: The HLR/HSS 180 sends a response message comprising the address of the MME 140 to the SMS-GMSC 160.

Step 808: The SMS-GMSC 160 sends a short message to the MME 140. If the MME 140 fails to deliver a mobile terminated (MT) short message service (SMS) via the LTE network 120 to the communication device 100, go to step 809. If the MME 140 succeeds to deliver the MT SMS via the LTE network 120 to the communication device 100, go to step 814.

Step 809: The MME 140 sends a redirect message to the SGSN 130.

Step 810: The SGSN 130 redirects the communication device 100 to the LTE network 120 if the communication device 100 is in the 2G/3G network 110.

Step 814: End.

In the process 80, the SMS-GMSC 160 sends the short message to the MME 140, and the MME 140 sends the redirect message to the SGSN 130 for informing the SGSN 130 that the short message is sent to the MME 140 and needs to be delivered to communication device 100. If the communication device 100 is in the 2G/3G network 110, the SGSN 130 redirects the communication device 100 to the LTE network 120, such that the MME 140 can deliver the short message by starting the MT SMS delivery procedure. If the communication device 100 is in the LTE network 120, the MME 140 can still deliver the short message by starting the MT SMS delivery procedure.

Note that, in the process 80, the SMS-GMSC 160 sends the short message to the MME 140 only, but is not limited thereto. The short message can be sent to the SGSN 130 first, such that the communication device 100 is redirected to the 2G/3G network 11 by the MME 140 if the communication device 100 is in the LTE network 120. Those skilled in the art should readily make combinations, modifications and/or alterations on the abovementioned description and examples.

In addition, to realize the processes 30-80, those skilled in the art should readily compile the processes 30-80 into program codes executed by corresponding blocks shown in FIG. 1. For example, each of the SGSN 130, the MME 140, the MSC 150, the SMS-GMSC 160, the SC 170 and the HLR/HSS 180 may include a processing means such as a microprocessor or Application Specific Integrated Circuit (ASIC), a storage unit and a communication interfacing unit. The storage unit maybe any data storage device that can store a program code, accessed and executed by the processing means. Examples of the storage unit include but are not limited to read-only memory (ROM), flash memory, random-access memory (RAM), CD-ROM/DVD-ROM, magnetic tape, hard disk and optical data storage device. The communication interfacing unit is preferably a transceiver and is used to transmit and receive signals (e.g., messages or packets) according to processing results of the processing means. In such a situation, the processes 30-80 may be compiled into program codes stored in storage units and executed by processing means of any one or any combinations of the SGSN 130, the MME 140, the MSC 150, the SMS-GMSC 160, the SC 170 and the HLR/HSS 180.

To sum up, the present invention provides a method of transferring a SMS to a communication device in a wireless communication system. In the prior art, a PS only device may fail to respond a CS paging message, and a location of the PS only device is uncertain when the PS only device is activated the ISR mode. The method of the present invention can resolve those problems by not activating the ISR mode for the communication device or delivering a short message through multiple nodes, to ensure the short message can be delivered to the communication device successfully.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of transferring a short message service (SMS) to a communication device in a wireless communication system, the method comprising:
a network of the wireless communication system not activating an idle-mode signaling reduction (ISR) mode for the communication device when the network applies only PS domain registration for the SMS for the communication device.

2. A method of transferring a short message service (SMS) to a communication device having activated an idle-mode signaling reduction (ISR) mode in a wireless communication system comprising a short message service gateway mobile switching center (SMS-GMSC) and a home location register (HLR)/home subscriber server (HSS), the method comprising:
the SMS-GMSC querying a routing information from the HLR/HSS; and
the SMS-GMSC sending a message indicating support of evolved packet system (EPS) and general packet radio service (GPRS).

3. The method of claim 2, wherein the communication device is a packet-switched (PS) only device, and the wireless communication system further comprises a serving GPRS support node (SGSN) and a mobility management entity (MME), and the method further comprises:
the HLR/HSS sending a response message comprising addresses of the SGSN or the MME or both to the SMS-GMSC.

4. The method of claim 3, further comprising:
the SMS-GMSC sending a short message to the SGSN and the MME; and
the SGSN and the MME starting mobile terminated (MT) short message service (SMS) delivery procedures respectively.

5. The method of claim 4, further comprising:
the SGSN sending an indication indicating that the short message has been delivered successfully to the SMS-GMSC if the SGSN successfully delivers the short message to the communication device; and
the SMS-GMSC notifying a service center (SC) that the short message has been delivered successfully, and instructing the MME to terminate the MT SMS delivery procedure when the SMS-GMSC receives the indication.

6. The method of claim 4, further comprising:
the MME sending an indication indicating that the short message has been delivered successfully to the SMS-GMSC if the MME successfully delivers the short message to the communication device; and
the SMS-GMSC notifying a service center (SC) that the short message has been delivered successfully, and instructing the SGSN to terminate the MT SMS delivery procedure when the SMS-GMSC receives the indication.

7. The method of claim 2, wherein the wireless communication system further comprises a mobile switching center (MSC) a serving GPRS support node (SGSN) and a mobility management entity (MME), and the method further comprises:
the HLR/HSS sending a response message comprising addresses of the MSC, the SGSN and the MME to the SMS-GMSC.

8. The method of claim 7, further comprising:
the SMS-GMSC sending a short message to the MSC; and
the MSC starting a SMS delivery procedure.

9. The method of claim 8, further comprising:
the SMS-GMSC sending the short message to the SGSN and the MME if the SMS delivery procedure by the MSC is failed; and
the SGSN and the MME starting mobile terminated (MT) short message service (SMS) delivery procedures respectively.

10. The method of claim 9, further comprising:
the SGSN sending an indication indicating that the short message has been delivered successfully to the SMS-GMSC if the SGSN successfully delivers the short message to the communication device; and
the SMS-GMSC notifying a service center (SC) that the short message has been delivered successfully, and instructing the MME to terminate the MT SMS delivery procedure when the SMS-GMSC receives the indication.

11. The method of claim 9, further comprising:
the MME sending an indication indicating that the short message has been delivered successfully to the SMS-GMSC if the MME successfully delivers the short message to the communication device; and
the SMS-GMSC notifying a service center (SC) that the short message has been delivered successfully, and instructing the SGSN to terminate the MT SMS delivery procedure when the SMS-GMSC receives the indication.

12. The method of claim 7, further comprising:
the SMS-GMSC sending a short message to the SGSN and the MME; and
the SGSN and the MME starting mobile terminated (MT) short message service (SMS) delivery procedures respectively.

13. The method of claim 12, further comprising:
the SMS-GMSC sending the short message to the MSC if both the MT SMS delivery procedures started by the SGSN and the MME are failed; and
the MSC starting a MT SMS delivery procedure.

14. The method of claim 3, further comprising:
the SMS-GMSC sending the short message to the MME; and
the MME sending a PS paging message to the SGSN over an S3 interface if the MME fails to receive a paging response from an evolved UMTS Terrestrial Radio Access Network (EUTRAN) or fails to a deliver mobile terminated (MT) short message service (SMS) via the EUTRAN to communication device.

15. The method of claim 14, further comprising:
the SGSN using an allocated packet-temporary mobile subscriber identity (P-TMSI) or international mobile subscriber identity (IMSI) as a temporary identity.

16. The method of claim 14, wherein the step of the MME sending a PS paging message to the SGSN over an S3 interface comprises:
the MME sending a PS paging message with a SMS service indicator to the SGSN over an S3 interface.

17. The method of claim 16, further comprising:
the MME sending the short message to the SGSN if the SGSN sends a paging response corresponding to the PS paging message to the MME over the S3 interface; and
the SGSN starting mobile terminated (MT) short message service (SMS) delivery procedures.

18. The method of claim 3, further comprising:
the SMS-GMSC sending the short message to the MME; and
the MME sending a circuit-switched (CS) paging message with a service indicator setting as “PS SMS indicator” to the SGSN over an S3 interface if the MME fails to a receive paging response from an evolved UMTS Terrestrial Radio Access Network (EUTRAN) or fails to deliver a mobile terminated (MT) short message service (SMS) via the EUTRAN to communication device.

19. The method of claim 18, further comprising:
the SGSN using an allocated packet-temporary mobile subscriber identity (P-TMSI) or international mobile subscriber identity (IMSI) as a temporary identity.

20. The method of claim 18, further comprising:
the SGSN sending a PS paging message over a PS domain when the SGSN receives the CS paging message with the service indicator setting as “PS SMS indicator”.

21. The method of claim 20, further comprising:
the MME sending the short message to the SGSN if the SGSN sends a paging response corresponding to the CS paging message to the MME over the S3 interface; and
the SGSN starting mobile terminated (MT) short message service (SMS) delivery procedures.

22. The method of claim 3, further comprising:
the SMS-GMSC sending the short message to the MME; and
the MME sending the short message to the SGSN over an S3 interface.

23. The method of claim 22, further comprising:
the SGSN and the MME starting mobile terminated (MT) short message service (SMS) delivery procedures respectively.

24. The method of claim 23, further comprising:
the SGSN sending an indication indicating that the short message has been delivered successfully to the SMS-GMSC if the SGSN successfully delivers the short message to the communication device; and
the SGSN instructing the MME to terminate the MT SMS delivery procedure.

25. The method of claim 23, further comprising:
the MME sending an indication indicating that the short message has been delivered successfully to the SMS-GMSC if the MME successfully delivers the short message to the communication device; and
the MME instructing the SGSN to terminate the MT SMS delivery procedure.

26. The method of claim 3, further comprising:
the SMS-GMSC sending the short message to the SGSN; and
the SGSN sending the short message to the MME over an S3 interface.

27. The method of claim 26, further comprising:
the SGSN and the MME starting mobile terminated (MT) short message service (SMS) delivery procedures respectively.

28. The method of claim 27, further comprising:
the SGSN sending an indication indicating that the short message has been delivered successfully to the SMS-GMSC if the SGSN successfully delivers the short message to the communication device; and
the SGSN instructing the MME to terminate the MT SMS delivery procedure.

29. The method of claim 27, further comprising:
the MME sending an indication indicating that the short message has been delivered successfully to the SMS-GMSC if the MME successfully delivers the short message to the communication device; and
the MME instructing the SGSN to terminate the MT SMS delivery procedure.

30. The method of claim 3, further comprising:
the SMS-GMSC sending the short message to the SGSN; and
the SGSN sending a redirect message to the MME if the SGSN fails to deliver a mobile terminated (MT) short message service (SMS) via a GSM EDGE Radio Access Network (GERAN) or an UMTS Terrestrial Radio Access Network (UTRAN).

31. The method of claim 30, further comprising:
the MME redirecting the communication device to a cell under a coverage of the SGSN if the communication device is under a coverage of the MME.

32. The method of claim 31, further comprising:
the SGSN starting a MTSMS delivery procedure.

33. The method of claim 3, further comprising:
the SMS-GMSC sending the short message to the MME; and
the MME sending a redirect message to the SGSN if the MME fails to deliver a mobile terminated (MT) short message service (SMS) via an evolved UMTS Terrestrial Radio Access Network (EUTRAN) to the communication device.

34. The method of claim 33, further comprising:
the SGSN redirecting the communication device to a cell under a coverage of the MME if the communication device is under a coverage of the SGSN.

35. The method of claim 34, further comprising:
the MME starting a MT SMS delivery procedure.
